(19) United States
(12) Patent Application Publication
(10) Pub. No.: US 2015/0267015 A1
(43) Pub. Date: Sep. 24, 2015

(54) Latex Products Containing Fillers from Wastes

(71) Applicant: OHIO STATE INNOVATION FOUNDATION, Columbus, OH (US)

(72) Inventors: Katrina Cornish, Wooster, OH (US); Jessica Lauren Slutzky, Wooster, OH (US)

(73) Assignee: OHIO STATE INNOVATION FOUNDATION, Columbus, OH (US)

(21) Appl. No.: 14/441,228

(22) PCT Filed: Nov. 14, 2013
(86) PCT No.: PCT/US13/70062

§ 371 Date: May 7, 2015

Related U.S. Application Data
(60) Provisional application No. 61/726,123, filed on Nov. 14, 2012.

(51) Int. Cl. C08J 5/18; B29C 41/14; C08K 13/02; C08J 3/26

(52) U.S. Cl. CPC C08J 5/18; C08J 3/26; B29C 41/14; C08K 13/02; C08J 2307/02; C08J 2497/02; C08J 2467/02; B29K 2007/00

(57) ABSTRACT

Latex products containing macro-, micro-, and nano-sized fillers made from agricultural, industrial, and food processing wastes, methods of making the same, and articles fabricated therefrom, are described.

### CROSS-REFERENCE TO RELATED APPLICATIONS

The present invention claims priority to U.S. Provisional Patent Application Ser. No. 61/726,123, filed under 35 U.S.C. §111(b) on Nov. 14, 2012, the disclosure of which is hereby incorporated by reference in its entirety.

### STATEMENT REGARDING FEDERALLY SPONSORED RESEARCH

This invention was made with no government support. The government has no rights in the invention.

### BACKGROUND OF THE INVENTION

Rubber is used as a raw material for the manufacture of over 40,000 products. All natural rubber (NR) and natural rubber latex (NRL) are primarily composed of cis-1,4-polyisoprene. Other components of NRL include proteins, fatty acids, resins, and lipids. However, there are over 2,500 species of plants that produce NRL, and rubber macromolecular structure varies among the species, as does polymer size, polydispersity, composition, gel content, rubber particle composition, particle size distribution, complexity of the rubber biosynthetic apparatus, and the NR properties of the products made from different rubbers. For example, the protein component of latex includes the proteins associated with the rubber particle membranes as well as the soluble and non-rubber particle-associated membrane-bound proteins that are entrained in the latex upon tapping. The soluble proteins can be removed from latex by washing using a series of concentration, dilution, and reconcentration steps, by enzymatic deproteination, provided this is followed by latex washing or thorough product leaching during manufacture, or by precipitation of soluble proteins. The lipid content of rubber particles from different species also varies significantly. In species which do not make tappable latex, such as guayule (which has to be homogenized to release the rubber particles from the bark parenchyma cells), the initial latex fraction (essentially the plant homogenate itself) contains large amounts of plant proteins extracted when the plant was homogenized to release the rubber particles. The latex is then purified away from the non-latex components. The compositional differences among different latices generate different chemistries which exert different effects when the latices are compounded. However, the mechanistic impact of these compositional differences on observed alterations in product performance are still poorly understood and can cause different interactions with fillers.

In most polymeric products, the polymer is the most expensive component. This has led to the use of the maximum possible loading of cheap mineral- or petroleum-based fillers in polymeric products. There is a need for additives in rubber-based products so as to reduce the amounts of rubber needed. Fillers have been used in rubber products for many decades and serve either as inexpensive diluents of the more expensive polymer phase or as reinforcing fillers to improve the physical properties of the rubber product. Diluent fillers must be especially low in cost to be of practical use. Historically, diluent fillers have been made from minerals of various kinds. In general, mineral fillers increase the modulus of the final product and, sometimes, tearing and abrasion resistance.

Many of these fillers greatly reduce the product performance of the products in which they are used. Reinforcing fillers are expensive, can have high carbon footprints, and generally require a very small particle size (<300 nm). Other fillers, such as silica, are polar and therefore difficult to incorporate into nonpolar NRL. Furthermore, geometric shape impacts the area of the particle, and the greater the surface area, the greater the interaction between filler and polymer. Compounding ingredients, such as ionic compounds, can also impact the surface activity of bio-based fillers. Thus, there is a need for low-cost fillers for polymeric products that do not result in decreased product performance.

### SUMMARY OF THE INVENTION

Provided herein is a latex compound comprising a rubber latex component; a crosslinking agent; one or more accelerators; and a filler comprising vegetable wastes, mineral wastes, or lignocellulosic wastes. In certain embodiments, the rubber latex component is selected from the group consisting of Hevea brasiliensis, guayule (Parthenium argentatum), gopher plant (Euphorbia lathyris), mariola (Parthenium incanum), rabbitbrush (Chrysothanmus nauseosus), candelilla (Pedilanthus macrocarpus), Madagascar rubbervine (Cryptostegia grandiflora), milkweeds (Asclepias syriaca, speciosa, subulata, et al.), goldenrods (Solidago altissima, graminifolia, rigida, et al.), Russian dandelion (Taraxacum kok-saghyz), mountain mint (Pycnanthemum incanum), American germander (Teucreum canadense), tall bellflower (Campanula americana), plants from the Asteraceae (Compositae), Euphorbiaceae, Campanulaceae, Labiatae, and Moraceae families, and a combination thereof. In certain embodiments, the rubber latex component is selected from the group consisting of guayule NRL, Vytex® latex, and Centex latex. In certain embodiments, the crosslinking agent is a source of sulfur. In certain embodiments, the filler comprises macro-sized particles having an average particle size of from about 38 μm to about 300 μm. In certain embodiments, the filler comprises micro-sized particles having an average particle size of from about 1 μm to about 38 μm. In certain embodiments, the filler comprises nano-sized particles having an average particle size of less than about 1 μm. In certain embodiments, the one or more accelerators comprises ZDEC, DPG, Sulfads®, or a combination thereof.

In certain embodiments, the filler comprises carbon fly ash, calcium carbonate from eggshells, guayule bark bagasse, tomato peel, tomato paste, PHVB, or floss. In certain embodiments, the latex compound further comprises one or more of ammonium hydroxide, antioxidants, or ZnO.

In certain embodiments, the rubber component of the latex compound is Centex latex, and the filler comprises eggshells at a concentration of from about 1 PHR to about 5 PHR. In certain embodiments, the rubber component is Centex latex, and the filler comprises carbon fly ash at a concentration of from about 1 PHR to about 5 PHR. In certain embodiments, the rubber component is Centex latex, and the filler comprises micro-sized or nano-sized guayule bark bagasse.

In certain embodiments, the rubber component is Vytex® latex, and the filler comprises micro-sized or nano-sized guayule bark bagasse. In certain embodiments, the rubber component is Vytex® latex, and the filler comprises macro-sized eggshells. In certain embodiments, the rubber component is Vytex® latex, and the filler comprises macro-sized carbon fly ash. In particular embodiments wherein the rubber component is Vytex® latex, the filler is present at about 2 PHR.

In certain embodiments, the rubber component is guayule NRL, and the filler comprises nano-sized eggshells. In certain embodiments, the rubber component is guayule NRL, and the filler comprises micro-sized or nano-sized carbon fly ash. In certain embodiments, the rubber component is guayule NRL, and the filler comprises micro-sized tomato peel. In certain embodiments, the rubber component is guayule NRL, and the filler comprises micro-sized tomato paste. In certain embodiments, the rubber component is guayule NRL, and the filler comprises micro-sized tomato peel. In certain embodiments, the rubber component is guayule NRL, and the filler comprises micro-sized bark bagasse.

Further provided herein is a latex film made from the latex compound described above. In certain embodiments, the latex film has a thickness ranging from about 0.03 mm to about 0.26 mm. In certain embodiments, the latex film has a thickness of about 0.15 mm. In certain embodiments, the latex film has a tensile strength of greater than 24 MPa. In certain embodiments, the latex film has an elongation to break of greater than 750%. In certain embodiments, the latex film has a modulus at 500% elongation of less than 5.5 MPa.

Further provided herein is a method of making a waste-filled dipped film. The method comprises the steps of compounding a latex emulsion comprising at least one waste filler selected from the group consisting of tomato peel, tomato paste, floss, PHVB, guayule bark bagasse, carbon fly ash, and eggshells; and crosslinking the latex emulsion through a vulcanization process to produce a waste-filled dipped film. In certain embodiments, a former is dipped in the latex emulsion for a dwell time to deposit a film of latex on the former. The former can be heated or non-heated. In certain embodiments, the former is coated with a coagulant prior to dipping in the latex emulsion. In certain embodiments, the dwell time is about 10 seconds. In certain embodiments, the method further comprises the steps of milling and sieving the waste filler to obtain a desired particle size prior to compounding the latex emulsion. Further provided herein is the product of this method.

Further provided herein are articles made from the waste-filled dipped films described above. In certain embodiments, the articles are surgical gloves, examination gloves, or condoms.

### BRIEF DESCRIPTION OF THE DRAWINGS

The patent or application file may contain one or more drawings executed in color and/or one or more photographs. Copies of this patent or patent application publication with color drawing(s) and/or photograph(s) will be provided by the U.S. Patent and Trademark Office upon request and payment of the necessary fees.

FIG. 1: Flowchart showing a process for manufacturing dipped thin films.

FIG. 2: Physical properties of Centex NRL filled with different loadings of three different fillers, each ground to a macro (300-38 μm), micro (38-1 μm) or nano (<1 μm) size. All films were of similar thickness, were made of the same compound, apart from the fillers, and were cured under the same conditions.

FIG. 3: Physical properties of Vytex® NRL filled with different loadings of three different fillers, each ground to a macro (300-38 μm), micro (38-1 μm), or nano (<1 μm) size. All films were of similar thickness, were made of the same compound, apart from the fillers, and were cured under the same conditions.

FIG. 4: Physical properties of guayule NRL (GNRL) filled with different loadings of three different fillers, each ground to a macro (300-38 μm), micro (38-1 μm), or nano (<1 μm) size. All films were of similar thickness, were made of the same compound, apart from the fillers, and were cured under the same conditions.

FIG. 5: Effect of micro filler type on tensile strength in films made from three latices. All fillers were 1-38 μm in size and were loaded at 1 PHR. All films were of similar thickness, were made of the same compound, apart from the fillers, and were cured under the same conditions.

FIG. 6: Effect of micro filler type of modulus (at 500% elongation) in films made from three latices. All fillers were 1-38 μm in size and were loaded at 1 PHR. All films were of similar thickness, were made of the same compound, apart from the fillers, and were cured under the same conditions.

FIG. 7: Effect of micro filler type of elongation to break on films made from three latices. All fillers were 1-38 μm in size and were loaded at 1 PHR. All films were of similar thickness, were made of the same compound, apart from the fillers, and were cured under the same conditions.

FIGS. 8A-C: SEM and TEM images of carbon fly ash fillers, showing primarily spherical geometry. FIG. 8A shows macro-sized carbon fly ash filler. FIG. 8B shows micro-sized carbon fly ash filler. FIG. 8C shows nano-sized carbon fly ash filler.

FIGS. 9A-C: SEM and TEM images of guayule bark bagasse fillers. FIG. 9A shows macro-sized guayule bark bagasse filler. FIG. 9B shows micro-sized guayule bark bagasse filler. FIG. 9C shows nano-sized guayule bark bagasse filler. The geometry changes from platy/spherical for micro-sized filler to more fiber-like for nano-sized filler.

FIGS. 10A-C: SEM and TEM images of calcium carbonate fillers from eggshells. FIG. 10A shows macro-sized calcium carbonate filler. FIG. 10B shows micro-sized calcium carbonate filler. FIG. 10C shows nano-sized calcium carbonate filler. Spherical geometry is seen in both micro- and nano-sized fillers.

FIG. 11: Graph showing modulus at 500% (MPa) of waste-filled Centex films. Most of the Centex films tested were generally softer than control films.

FIG. 12: Graph showing modulus at 500% (MPa) of waste-filled Vytex® films. Most of the Vytex® films tested were generally softer than control films.

FIG. 13: Graph showing modulus at 500% (MPa) of waste-filled guayule films. The guayule films tested had increased stiffness for micro- and macro-fillers with low loadings. The guayule films softened with nano-sized fillers.

FIG. 14: Graph showing elongation at break (%) of waste-filled Centex films. The waste-filled Centex films had decreasing elongation with higher filler loadings. The nano-sized fillers increased elongation.

FIG. 15: Graph showing elongation at break (%) of waste-filled Vytex® films. The waste-filled Vytex® films had increasing elongation with higher filler loadings. The nano-sized fillers also increased elongation.

FIG. 16: Graph showing elongation at break (%) of waste-filled guayule films. The waste-filled guayule films had increasing elongation with higher filler loadings. The nano-sized fillers also increased elongation.

FIG. 17: Graph showing tensile strength (MPa) of waste-filled Centex films. The waste-filled Centex films had decreased tensile strength. Various waste-filled Centex films had tensile strength above 24 MPa, making them commercially viable.

FIG. 18: Graph showing tensile strength (MPa) of waste-filled guayule films. The waste-filled guayule films had decreased tensile strength. Various waste-filled guayule films had tensile strength above 24 MPa, making them commercially viable.

FIG. 19: Graph showing tensile strength (MPa) of waste-filled Vytex® films. The waste-filled Vytex® films had decreased tensile strength. Various waste-filled Vytex® films had tensile strength above 24 MPa, making them commercially viable.

### DETAILED DESCRIPTION OF THE INVENTION

Various embodiments are described in the present disclosure in the context of latex compounds, latex films, methods of making latex films, and methods of using latex films. Those of ordinary skill in the art will realize that the following detailed description of the embodiments is illustrative only and not intended to be in any way limiting. Other embodiments will readily suggest themselves to such skilled persons having the benefit of this disclosure. Reference to an “embodiment,” “aspect,” or “example” in this disclosure indicates that the embodiments of the invention so described may include a particular feature, structure, or characteristic, but not every embodiment necessarily includes the particular feature, structure, or characteristic. Further, repeated use of the phrase “in one embodiment” does not necessarily refer to the same embodiment, although it may.

Not all of the routine features of the implementations or processes described herein are shown and described. It will, of course, be appreciated that in the development of any such actual implementation, numerous implementation-specific decisions will be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking for those of ordinary skill in the art having the benefit of this disclosure.

### DEFINITIONS

For convenience, certain terms employed in the specification, examples, and appended claims are collected here, before further description of the invention. These definitions should be read in light of the remainder of the disclosure and understood as by a person of skill in the art. Unless defined otherwise, all technical and scientific terms used herein have the same meaning as commonly understood by a person of ordinary skill in the art.

The articles “a” and “an” are used to refer to one or to more than one (i.e., to at least one) of the grammatical object of the article. By way of example, “an element” means one element or more than one element.

The term “plurality” means more than one.

The terms “comprise” and “comprising” are used in the inclusive, open sense, meaning that additional elements may be included.

The term “including” is used to mean “including but not limited to”. “Including” and “including but not limited to” are used interchangeably.

The term “elastomer” refers to a polymer that displays rubber-like elasticity.

The term “vulcanization” refers to a chemical process for modifying a polymer by forming crosslinks between individual polymer chains.

The terms “vulcanizate” or “vulcanisate” as used interchangeably herein refer to the product of a vulcanization process. A vulcanizate is a cross-linked polymer.

The term “tensile strength” refers to the maximum amount of tensile stress a material can withstand before breaking.

The term “floss” refers to any silky or fibrous material obtained from plants, such as fibers obtained from cotton.

The acronym “PHR” stands for Parts per Hundred Rubber, which is a measure of concentration known in the rubber compounding art. As used herein, “PHR” means a proportion of a component per 100 grams of elastomer.

The term “modulus” refers to elastic modulus, or the tendency of an object to be deformed elastically when a force is applied to it. Modulus is also an indicator of the softness of an object: the lower the modulus, the softer the material.

The term “coagulate” refers to a change from a liquid or a sol into a thickened mass. The term “coagulant” refers to an agent that causes a liquid or a sol to coagulate.

The term “MPa” refers to a megapascal, or 1,000,000 Pa. A pascal is a measure of force per unit area. One pascal is equal to one newton per square meter (1 N/m²).

### GENERAL DESCRIPTION

The largest consumption of dipped films is the medical glove market. Surgical gloves require the highest physical performance to protect both surgeon and patient from the transmission of human disease, especially via blood borne pathogens. Type I natural rubber surgical gloves are stronger, softer, and more elastic than the Type II synthetic gloves, characteristics which make them considerably more comfortable to wear, especially for protracted periods of time. Table 1 below displays the before-aging physical property tensile specifications from ASTM 3577 for surgical gloves having a minimum thickness of 0.1 mm. Type I gloves are NRL and Type II gloves are synthetic gloves.

TABLE 1
ASTM 3577 Standards for Surgical Gloves

| | Tensile strength | Elongation to break | Modulus at 500% |
|---|---|---|---|
| Type | (MPa) | (%) | (MPa) |
| I | 24 min | 750 min | 5.5 max |
| II | 17 min | 650 min | 7.0 max |

Latex compounds can be compounded with fillers which can serve either as inexpensive diluents of the more expensive polymer phase or reinforcing fillers to improve the physical properties of the product. Fillers of various types are used as material diluents to lower the cost of dipped latex film products, but often to the detriment of their physical properties. Thus, to meet an unmet need in the industry, provided herein are dipped films in which different loadings of macro-, micro-, and nano-sized fillers made from sustainable wastes, such as food and agricultural processing wastes, have been incorporated. In certain embodiments, the waste-filled dipped films meet or exceed the ASTM 3577 standards for surgical gloves. In certain embodiments, the dipped films are made of Centex latex, Vytex® latex, guayule NRL (GNRL), or combinations thereof. As the examples below illustrate, the different latices respond differently to different fillers. Many of the dipped films produced and described in the examples exceed the ASTM 3577 surgical glove specifications and improve the properties of unfilled films.

The fillers are macro-, micro-, or nano-fillers made from high volume wastes. The macro-fillers generally have a particle size ranging from about 38 microns to about 300 microns. The micro-fillers generally have a particle size ranging from about 1 micron to about 38 microns, and can be made from dry milling and sieving suitable wastes. The nano-fillers generally have a particle size of smaller than 1 micron, and can be made from dry milling, or wet willing, and sieving suitable wastes. In certain embodiments, the particle size of the fillers is smaller than the interchain distance of the polymer, and can be made from wet milling suitable wastes in water via pebble milling. The three sizes of fillers can improve product performance while reducing polymer usage in latex and rubber product manufacturing. Without wishing to be bound by theory, the mechanical properties of filled films are improved via a reinforcing effect that utilizes phenomena such as molecular surface rearrangements, particle displacements, interparticle chain breakage, and strong and weak binding. As will be made apparent from the examples, careful selection of filler type, size distribution, and loading can be used to specifically alter individual aspects of physical performance without changing other aspects. Thus, the customization of film properties for specific product applications is possible with the benefit of the present disclosure.

Food processing, industrial, and agricultural wastes are residual materials produced during the conversion of agricultural commodities into marketable food items, and include wastes from raw materials, pre- and post-processing wastes, industrial effluents, and sludge. The normal disposal modes of solid wastes are composting and landfill applications, which create additional cost for processing companies. Only 3% of food wastes are recycled in the U.S., largely due to inadequate infrastructure to process the enormous quantity of food wastes, monetary restrictions of recycling facilities, and the presence of potential contaminants in some food wastes. This abundant, unused supply means that a wide range of bio-based and mineral waste materials are available in quantities suitable for large-scale production of different products having wastes as functional fillers. The skilled person will understand that the waste materials described herein can be readily modified by milling or by chemical treatments in order to alter and optimize their interaction with polymer matrices, and that such alterations or optimizations are entirely within the scope of the present disclosure.

Many different types of wastes are possible as fillers in dipped films. By way of non-limiting example, suitable wastes for use as fillers in dipped films include, but are not limited to: vegetable wastes such as tomato paste or tomato peel, as well as peels of potatoes, onions, lemons, tangerines, bananas, kiwis, or the like; mineral wastes such as carbon fly ash (the waste generated from burning coal), calcium carbonate from eggshells (with and without the membrane peeled off), bauxite residues, drilling debris, aluminum dross, cement waste, coal mine schist, geological mine tailings, sewage sludge ash, sludge solids, steel slag, zeolites, or zinc slag; bioplastics such as polyhydroxy butrate valerate (PHBV), starch-based plastics, polylactic acid (PLA) plastics, poly-3-hydroxyburtyrate (PHB), poly-3-hydroxyalkanoate (PHA), polyamide 11 (PA 11) plastics, or floss; lignocellulosic wastes such as bagasse from the rubber-producing crops guayule or Kazak dandelion (Buckeye Gold), paper sludge, cardboard, straw, sawdust, or bark from pine in its different varieties such as radiate, cry, eucalyptus, acacia, oak, rauli, and beech; biofuels crop wastes, such as corn stover; or combinations thereof. In specific examples described herein, dipped films were produced loaded with fillers selected from tomato paste, tomato peels, carbon fly ash (from post-coal combustion), calcium carbonate from eggshells (without membrane), PHBV, floss, guayule bark bagasse, and Kazak dandelion bagasse. Bagasse is a suitable filler because the residual rubber (and resin in guayule) in the bagasse causes an additional interaction with the polymer blend as it becomes part of the active compound.

The production of dipped films filled with food, agricultural, or industrial wastes is a downstream utilization of such waste, and therefore saves in waste disposal costs. The films can be produced with lower costs than other latex films, and, as shown in the example below, have comparable or better performance characteristics than other latex films. It should be understood that films can be made with a combination of fillers. Generally, the behavior of such films can be predicted from the behavior of films with single fillers. Therefore, the examples given below illustrate films with single fillers and demonstrate that films having multiple fillers are entirely within the scope of the present disclosure.

In general, the filled latex films can be made using any of several possible latex latices as a rubber component. By way of non-limiting example, suitable latices include, but are not limited to, latex from the following plant species: Brazilian rubber tree (Hevea brasiliensis), guayule (Parthenium argentatum), gopher plant (Euphorbia lathyris), mariola (Parthenium incanum), rabbitbrush (Chrysothanmus nauseosus), candelilla (Pedilanthus macrocarpus), Madagascar rubbervine (Cryptostegia grandiflora), milkweeds (Asclepias syriaca, speciosa, subulata, et al.), goldenrods (Solidago altissima, graminfolia, rigida, et al.), Russian dandelion (Taraxacum kok-saghyz), mountain mint (Pycnanthemum incanum), American germander (Teucreum canadense), tall bellflower (Campanula americana), and plants from the Asteraceae (Compositae), Euphorbiaceae, Campanulaceae, Labiatae, and Moraceae families, Currently, only NRL from Hevea and guayule are commercially produced. However, any of the above natural rubber sources are capable of being used in the methods and recipes discussed herein to produce useful filled dipped films.

In particular examples herein, waste-filled dipped films were produced in Vytex®, Centex, and guayule latices. Vytex® is a Hevea latex with no soluble proteins. Because Vytex® has a reduced protein content, Vytex® materials enhanced with the use of fillers provide new materials that combine the reduction of risk of Type I latex allergy with improved physical performance. Similarly, purified guayule latex contains less than 1% of the protein content of Hevea latex and these proteins do not cross-react with Type I latex allergy. In addition, 90% of the trace proteins in guayule latex in the cytochrome P450 oxidase are allene oxide synthase. The P450-protein family has not been associated with any allergic reactions in humans. Therefore, the use of particular fillers in guayule latex, which poses no risk of Type I latex allergy, provides new materials that combine an eliminated risk of Type I allergy with improved tensile properties. Centex latex, on the other hand, is a Hevea latex with high protein content.

To make a waste-filled dipped film, a latex emulsion is compounded from one or more natural rubber latex components, one or more waste fillers as described above, a source of sulfur, and one or more accelerators. The waste fillers can be present at dry weight concentrations ranging from about 0 PHR to about 35 PHR, from about 5 PHR to about 20 PHR, or from about 10 PHR to about 15 PHR.

The source of sulfur can be elemental sulfur or one or more sulfur-containing compounds. Suitable sources of sulfur include, but are not limited to: sulfur powder; precipitated sulfur; colloidal sulfur; insoluble sulfur; high-dispersible sulfur; sulfur halides such as sulfur monochloride and sulfur dichloride; sulfur donors such as 4,4′-dithiodimorpholine; sulfur dispersions; amine disulfides; polymeric polysulfides; aromatic thiazoles; amine salts of mercaptobenzothiazoles; and combinations thereof. In certain embodiments, the sulfur is a sulfur dispersion. By way of non-limiting example, sulfur dispersions can be prepared by mixing elemental sulfur with a resin and a solvent. In certain embodiments, the dry weight concentration of the crosslinking agent ranges from about 0.01 PHR to about 5 PHR, from about 0.1 PHR to about 3.5 PHR, or from about 1 PHR to about 3 PHR. In particular embodiments, the crosslinking agent is present at a concentration of about 2 PHR.

The one or more accelerators can be selected from a wide variety of suitable accelerators. Suitable accelerators include, but are not limited to, xanthates, dithiocarbamates, thiurams, thiazoles, sulfonamides, guanidines, thiourea derivatives, and amine derivatives. More specifically, suitable accelerators include, but are not limited to: zinc diethyldithiocarbamate (ZDEC), diphenyl guanidine (DPG), Sulfads® (a sulfur donor for NR and synthetic polymers), zinc 2-mercaptobenzothiazole (ZMBT), diisopropyl xanthogen polysulphide (DIXP), zinc diisononyl dithiocarbamate (ZDNC), 2-cyclohexyl-benzothiazyl-sulfenamide (CBS), benzothiazyl-2-tert-butylsulfenamide (TBBS), tetramethylthiuram disulfide, 2-mercaptobenzothiazole (MBT), benzothiazyl-2-sulfenomorepholide (MBS), benzothiazyldicyclohexylsulfenamid (DCBS), diorthotolylguanidine (DOTG), o-tolyl biguanide (OTBG), tetramethylthiuram monosulfide (TMTM), zinc N-dimethyldithiocarbamate (ZDMC), zinc N-dibutyldithiocarbamate (ZDBC), zinc N-ethyl-phenyl-dithiocarbamate (ZEBC), zinc N-pentamethylendithiocarbamate (ZPMC), ethylene thiourea (ETU), diethylene thiourea (DETU), diphenyl thiourea (DPTU), or a combination thereof. In certain embodiments, the accelerators comprise ZDEC, DPG, Sulfads®, or a combination thereof.

The accelerators can each be present at dry weight concentrations ranging from about 0.01 PHR to about 5 PHR, or from about 0.1 PHR to about 2 PHR, or from about 0.2 PHR to about 1 PHR. In certain embodiments, the accelerator ZDEC is present at a concentration of about 0.5 PHR. In certain embodiments, the accelerator DPG is present at a concentration of about 0.4 PHR. In certain embodiments, Sulfads® accelerator is present at a concentration of about 0.6 PHR.

The latex compound may further include one or more of ZnO, ammonium hydroxide, or antioxidants. The antioxidants can be present in the form of an antioxidant dispersion. When present, the dry weight concentration of the ammonium hydroxide ranges from about 0.01 PHR to about 5 PHR, from about 0.1 PHR to about 3 PHR, or from about 0.8 PHR to about 2 PHR. In particular embodiments, ammonium hydroxide is present at a concentration of about 1 PHR. When present, the dry weight concentration of the ZnO ranges from about 0.01 PHR to about 2 PHR, from about 0.1 PHR to about 1 PHR, or from about 0.2 PHR to about 0.5 PHR. In particular embodiments, ZnO is present at a concentration of about 0.3 PHR. When present, the dry weight concentration of the antioxidants ranges from about 0.01 PHR to about 5 PHR, from about 0.1 PHR to about 4 PHR, or from about 1 PHR to about 3 PHR. In particular embodiments, the antioxidants are present at a concentration of about 2 PHR.

Table A below displays general compounding recipes for the latex compound used to make waste-filled dipped films.

TABLE A
General Compounding Recipes (all units parts per hundred rubber, PHR)

| Ingredient | Recipe 1 | Recipe 2 | Recipe 3 | Recipe 4 |
|---|---|---|---|---|
| Rubber | 1-100 | 50-100 | 75-100 | 100 |
| Component | | | | |
| Sulfur | 0.01-5.0 | 0.1-3.5 | 1.0-3.0 | Approx. 2.0 |
| ZDEC | 0.01-5.0 | 0.1-2.0 | 0.2-1.0 | Approx. 0.5 |
| DPG | 0.01-5.0 | 0.1-2.0 | 0.2-1.0 | Approx. 0.4 |
| Sulfads ® | 0.01-5.0 | 0.1-2.0 | 0.2-1.0 | Approx. 0.6 |
| Ammonium | 0.00-5.0 | 0.1-3.0 | 0.8-2.0 | Approx. 1.0 |
| hydroxide | | | | |
| Zinc oxide | 0.00-2.0 | 0.1-1.0 | 0.2-0.5 | Approx. 0.3 |
| Antioxidant | 0.00-5.0 | 0.1-4.0 | 1.0-3.0 | Approx. 2.0 |
| Waste Filler | 0.01-35.0 | 0.1-20.0 | 0.5-15.0 | Approx. 1.0, 2.0, |
| | | | | 5.0, or 10.0 |

Table B below displays various examples of compounding recipes for guayule NRL.

TABLE B
Example Compounding Recipes for Guayule NRL
(all units parts per hundred rubber, PHR)

| Ingredient | Recipe 1 | Recipe 2 | Recipe 3 | Recipe 4 |
|---|---|---|---|---|
| Guayule NRL | 100 | 100 | 100 | 100 |
| Sulfur | Approx. 2.0 | Approx. 2.0 | Approx. 2.0 | Approx. 2.0 |
| ZDEC | Approx. 0.5 | Approx. 0.5 | Approx. 0.5 | Approx. 0.5 |
| DPG | Approx. 0.4 | Approx. 0.4 | Approx. 0.4 | Approx. 0.4 |
| Sulfads ® | Approx. 0.6 | Approx. 0.6 | Approx. 0.6 | Approx. 0.6 |
| Ammonium | Approx. 1.0 | Approx. 1.0 | Approx. 1.0 | Approx. 1.0 |
| hydroxide | | | | |
| Zinc oxide | Approx. 0.3 | Approx. 0.3 | Approx. 0.3 | Approx. 0.3 |
| Antioxidant | Approx. 2.0 | Approx. 2.0 | Approx. 2.0 | Approx. 2.0 |
| Waste Filler | Approx 1.0 | Approx. 2.0 | Approx. 5.0 | Approx. 10.0 |

Table C below displays various examples of compounding recipes for Vytex® latex.

TABLE C
Example Compounding Recipes for Vytex ® NRL
(all units parts per hundred rubber, PHR)

| Ingredient | Recipe 1 | Recipe 2 | Recipe 3 | Recipe 4 |
|---|---|---|---|---|
| Vytex ® latex | 100 | 100 | 100 | 100 |
| Sulfur | Approx. 2.0 | Approx. 2.0 | Approx. 2.0 | Approx. 2.0 |
| ZDEC | Approx. 0.5 | Approx. 0.5 | Approx. 0.5 | Approx. 0.5 |
| DPG | Approx. 0.4 | Approx. 0.4 | Approx. 0.4 | Approx. 0.4 |
| Sulfads ® | Approx. 0.6 | Approx. 0.6 | Approx. 0.6 | Approx. 0.6 |
| Ammonium | Approx. 1.0 | Approx. 1.0 | Approx. 1.0 | Approx. 1.0 |
| hydroxide | | | | |
| Zinc oxide | Approx. 0.3 | Approx. 0.3 | Approx. 0.3 | Approx. 0.3 |
| Antioxidant | Approx. 2.0 | Approx. 2.0 | Approx. 2.0 | Approx. 2.0 |
| Waste Filler | Approx 1.0 | Approx. 2.0 | Approx. 5.0 | Approx. 10.0 |

Table D below displays various examples of compounding recipes for Centex latex.

TABLE D
Example Compounding Recipes for Centex latex
(all units parts per hundred rubber, PHR)

| Ingredient | Recipe 1 | Recipe 2 | Recipe 3 | Recipe 4 |
|---|---|---|---|---|
| Centex latex | 100 | 100 | 100 | 100 |
| Sulfur | Approx. 2.0 | Approx. 2.0 | Approx. 2.0 | Approx. 2.0 |
| ZDEC | Approx. 0.5 | Approx. 0.5 | Approx. 0.5 | Approx. 0.5 |
| DPG | Approx. 0.4 | Approx. 0.4 | Approx. 0.4 | Approx. 0.4 |
| Sulfads ® | Approx. 0.6 | Approx. 0.6 | Approx. 0.6 | Approx. 0.6 |
| Ammonium | Approx. 1.0 | Approx. 1.0 | Approx. 1.0 | Approx. 1.0 |
| hydroxide | | | | |
| Zinc oxide | Approx. 0.3 | Approx. 0.3 | Approx. 0.3 | Approx. 0.3 |
| Antioxidant | Approx. 2.0 | Approx. 2.0 | Approx. 2.0 | Approx. 2.0 |
| Waste Filler | Approx 1.0 | Approx. 2.0 | Approx. 5.0 | Approx. 10.0 |

Further provided herein are latex compounds that include more than one elastomers, and waste-filled dipped films made therefrom. Table F below displays non-limiting examples of possible alternative compounding recipes that include more than one elastomer.

TABLE E
Alternative Compounding Recipes
(all units parts per hundred rubber, PHR)

| Ingredient | Recipe 1 | Recipe 2 | Recipe 3 | Recipe 4 |
|---|---|---|---|---|
| First Rubber | 1-100 | 50-100 | 75-100 | 100 |
| Component | | | | |
| Second Rubber | 1-100 | 50-100 | 0-20 | 0 |
| Component | | | | |
| Sulfur | 0.01-5.0 | 0.1-3.5 | 1.0-3.0 | Approx. 2.0 |
| ZDEC | 0.01-5.0 | 0.1-2.0 | 0.2-1.0 | Approx. 0.5 |
| DPG | 0.01-5.0 | 0.1-2.0 | 0.2-1.0 | Approx. 0.4 |
| Sulfads ® | 0.01-5.0 | 0.1-2.0 | 0.2-1.0 | Approx. 0.6 |
| Ammonium | 0.00-5.0 | 0.1-3.0 | 0.8-2.0 | Approx. 1.0 |
| hydroxide | | | | |
| Zinc oxide | 0.00-2.0 | 0.1-1.0 | 0.2-0.5 | Approx. 0.3 |
| Antioxidant | 0.00-5.0 | 0.1-4.0 | 1.0-3.0 | Approx. 2.0 |
| Waste Filler | 0.01-35.0 | 0.1-20.0 | 0.5-15.0 | Approx. 5.0, 10.0, |
| | | | | 20.0, or 35.0 |

Because the waste fillers can be milled and/or sieved to desirable sizes, various combinations of fillers and sizes are possible. Table G, below, displays some examples of specific types and sizes of waste fillers in specific rubber components. These are given by way of non-limiting example only; many other combinations are possible, and many other combinations are described as having been produced in the examples below.

TABLE F
Specific Combinations of Fillers and Sizes
(all units parts per hundred rubber, PHR)

| Recipe 1 | Recipe 2 | Recipe 3 |
|---|---|---|
| Centex latex | Vytex ® latex | Guayule NRL |
| ZDEC Accelerator | ZDEC Accelerator | ZDEC Accelerator |
| DPG Accelerator | DPG Accelerator | DPG Accelerator |
| Sulfads ® | Sulfads ® | Sulfads ® |
| Accelerator | Accelerator | Accelerator |
| Sulfur | Sulfur | Sulfur |
| Ammonium | Ammonium | Ammonium |
| Hydroxide | Hydroxide | Hydroxide |
| ZnO | ZnO | ZnO |
| Antioxidant | Antioxidant | Antioxidant |
| Micro-sized | Nano-sized carbon | Micro-sized |
| guayule bark | fly ash, nano-sized | tomato peel, |
| bagasse, nano- | guayule bark | micro-sized |
| sized eggshell | bagasse, macro- | tomato peel, or |
| calcium carbonate, | sized eggshell | nano-sized |
| or macro-sized | calcium carbonate, | guayule bark |
| carbon fly ash | or micro-sized | bagasse |
| | tomato paste | |

As seen from the examples described below, the waste-filled dipped films have stronger tensile properties with smaller particle sizes at lower loadings. A reinforcing effect is seen with low loadings of nano-sized fillers. Elongation at break is increased in latex films with waste fillers compared to latex films without fillers. Many waste-filled dipped films exceed the tensile requirements described in ASTM D 3577, the surgical glove standard. Thus, latex films with sustainable fillers can create polymer films with properties desirable in many applications, such as increased elongation at break. The use of such fillers can also decrease manufacturing costs. Without wishing to be bound by theory, the alteration of physical properties is likely due to several factors. Fatty acids are linked to the rubber chain at the chain-terminal and are unbonded in the emulsion. Stress-induced crystallization is attributed to mixed fatty acids and linked fatty acid ester groups on the rubber terminal. Higher fatty acid organization with lower protein content is thus attributed to better latex stabilization.

Methods of Making

Provided herein are methods of making dipped films filled with industrial, agricultural, or food wastes. Such films can be made by coagulant dipping, straight dipping, spray coating, casting processes, or foaming processes. For ease of explanation, a coagulant dipping process is described below, but it must be understood that any of these methods may be utilized to produce waste-filled dipped films, and such utilization is entirely within the scope of the present disclosure.

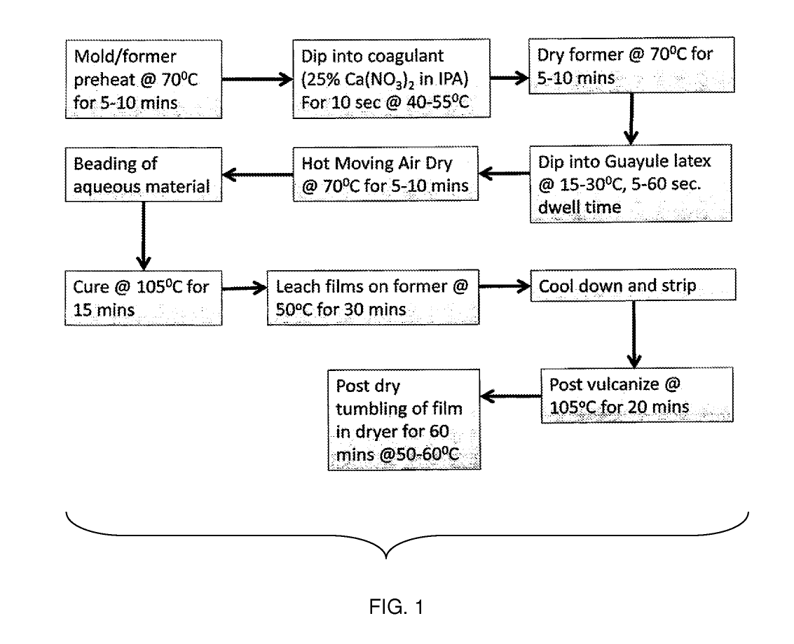

FIG. 1 is a flow-chart depicting an example method of manufacturing waste-filled dipped films. This method is merely an example, and is not intended to be in any way limiting. As seen in FIG. 1, a dipping process generally starts with a mold or former being pre-heated, though pre-heating is not necessary. The former can be one of many suitable materials, including, but not limited to, porcelain, glass, or stainless steel. In certain embodiments, the pre-heating lasts for about 5-10 minutes at a temperature of about 70° C. The former is dipped into a coagulant solution. The coagulant solution can be any suitable solution that tends to neutralize surfactants in latex emulsions or destabilize latex in order to cause the latex to gel and adhere as a film on the surface of the former. Suitable coagulant solutions include, but are not limited to, a mixture of aqueous calcium nitrate and isopropyl alcohol; potassium aluminum sulfate; or triethylenetetramine. In a particular embodiment, the coagulant solution is 25% aqueous calcium nitrate in 70% isopropyl alcohol. In some embodiments, following the dipping of the former into the coagulant solution, solvent is evaporated off the former before the process continues. By way of non-limiting example, the former is dried at about 70° C. for about 5-10 minutes to evaporate the solvent.

The coagulant-coated former is dipped into a latex emulsion for a particular dwell time in order to deposit a thin film of latex onto the former. In certain embodiments, the latex is filtered before dipping. The latex emulsion is compounded as described above, and can be of any suitable latex compound having one or more waste fillers. In particular examples, the latex emulsion comprises Vytex® latex, Centex latex, or guayule NRL, and the one or more waste fillers is selected from the group consisting of: carbon fly ash, eggshells, guayule bark bagasse, tomato peel, tomato paste, PHVB, or floss. The dipping dwell time can be any time from about 5 seconds to about 60 seconds. In particular embodiments, the dwell time is about 10 seconds. In particular embodiments, the temperature of the emulsion upon dipping is from about 15° C. to about 30° C. Hot moving air then dries the dipped former. In certain embodiments, the drying lasts for about 5-10 minutes at a temperature of about 70° C. The drying causes aqueous material to bead off the former. The latex is then cured. In certain embodiments, the curing lasts for about 15 minutes at a temperature of about 105° C.

Once cured, the latex films are leached on the former. Leaching times and temperatures can vary. In certain embodiments, the leaching lasts for about 30 minutes at a temperature of about 50° C. In certain embodiments, no wet gel leaching is required. Once leached, the latex is cooled and then stripped from the former. The resulting rubber article is then vulcanized. The temperature and time duration of vulcanization may vary. In a particular embodiment, vulcanization lasts for about 20 minutes at a temperature of about 105° C. In certain embodiments, the vulcanized rubber film is then tumble-dried for about 60 minutes at a temperature of from about 50° C. to about 60° C.

The thickness of the waste-filled dipped films generally ranges from about 0.03 mm to about 0.90 mm, but other thicknesses are possible by varying the dwell time of the former in the latex emulsion. In certain embodiments, the thickness ranges from about 0.15 mm to about 0.26 mm. In certain embodiments, the thickness of the waste-filled dipped films is about 0.23 mm.

The physical characteristics of the waste-filled dipped films vary based on filler particular size and filler loading rate. The characteristics of the resulting films are thus customizable to achieve desired properties for specific application. In certain embodiments, the waste-filled dipped films meet or exceed the ASTM standards for surgical gloves. By way of non-limiting example, Table 3 below displays possible ranges of performance characteristics of waste-filled dipped films.

TABLE 3
Waste-Filled Dipped Film Characteristics

| Characteristic | Range 1 | Range 2 | Range 3 | Range 4 |
|---|---|---|---|---|
| Thickness | 0.03-0.90 mm | 0.03-0.50 mm | 0.15-0.50 mm | 0.15-0.26 mm |
| Tensile Strength | 4.9-41.87 MPa | 7.89-37.1 MPa | 13.53-36.4 MPa | 17.91-31.91 MPa |
| Stress at 500% | 1.06-10.28 MPa | 1.06-7.0 MPa | 1.06-6.36 MPa | 1.06-5.5 MPa |
| Elongation | | | | |
| Ultimate | 773-2328% | 957-2328% | 1193-2328% | 1193-2085% |
| Elongation | | | | |

Among other benefits, the resulting waste-filled dipped films are less tacky, making them advantageous for mixing and injection mold applications.

Fabricated Articles

The filled dipped films herein are less expensive to produce and have advantageous physical performance characteristics. Therefore, the waste-filled dipped films are useful in a wide variety of fabricated articles. By way of non-limiting example, the waste-filled dipped films of the present disclosure can be fabricated into, or otherwise applied in the fabrication of: surgical gloves, condoms, dental dams, balloons, clothing elastic, wound dressings, tracheal tube cuffs, catheters, laboratory testing equipment, assays, disposable kits, drug containers, syringes, valves, seals, ports, plungers, forceps, droppers, stoppers, bandages, examination sheets, wrappings, coverings, tips, shields, sheaths for endo-devices, solution bags, thermometers, spatulas, tubing, binding agents, transfusion and storage systems, needle covers, tourniquets, tapes, masks, stethoscopes, medical adhesives, and any other dipped or open-cell foam latex product. Many other applications of the thin films are envisioned and within the scope of the present disclosure.

The articles described herein can be fabricated from waste-filled dipped films in any of a variety of fabrication methods. These methods include, but are certainly not limited to, coagulant dipping processes, straight-dipping processes, casting processes, and foaming processes. Thinner films are generally produced from a straight-dipping process wherein no pre-dipping in coagulant is done. Accordingly, a straight-dipping process is the preferred method of making articles preferably having thinner films, such as condoms. Though dipping processes have been specified to exemplify certain aspects of the articles made from the filled dipped films, the skilled practitioner will understand that casting and foaming processes for making waste-filled dipped films and articles are entirely within the scope of the present disclosure.

Kits

Further provided are kits for practicing the waste-filled dipped films and methods described herein. In certain embodiments, a kit includes a rubber latex component and one or more waste fillers in separate containers. In certain embodiments, the kit houses multiple waste fillers in multiple containers. In certain embodiments, the kit includes one or more of accelerators, ammonium hydroxide, ZnO, a sulfur dispersion, an antioxidant dispersion, a coagulant solution, or a former. Many other kits are possible. The kits may further include instructions for using the components of the kit to practice the subject methods. The instructions for practicing the subject methods are generally recorded on a suitable recording medium. For example, the instructions may be present in the kits as a package insert or in the labeling of the container of the kit or components thereof. In other embodiments, the instructions are present as an electronic storage data file present on a suitable computer readable storage medium, such as a flash drive, CD-ROM, or diskette. In other embodiments, the actual instructions are not present in the kit, but means for obtaining the instructions from a remote source, such as via the internet, are provided. An example of this embodiment is a kit that includes a web address where the instructions can be viewed and/or from which the instructions can be downloaded. As with the instructions, this means for obtaining the instructions is recorded on a suitable substrate.

### EXAMPLES

### Example 1

### Waste Fillers

Various wastes were collected from Ohio food processing and agricultural industries, and were evaluated for their utility in downstream, value-added conversion to fillers of dipped latex films. The fillers were evaluated in three matrix materials: Guayule natural rubber latex (GNRL), Centex NRL, and Vytex® NRL. The Centex NRL and Vytex® NRL were purchased from Centrotrade US. The GNRL was prepared and had solids of 53.5% by weight, a cis-1,4-polyisoprene content of greater than 99%, and a density of approximately 0.95 g·cm⁻³. The elemental composition of the GNRL was determined by ICP at the OSU-STAR Laboratory.

Vegetable Wastes

Processing tomato paste and peel were provided initially as frozen material by The Ohio State University's Department of Food Science and Technology (Columbus, Ohio), and later as waste peel by Hirzels of Sandusky, Ohio. The tomato wastes were thawed at room temperature, if frozen, and all peels were dried at 50° C. in a convection oven for several days. The dried tomato wastes were ground using an IKA All basic mill (Wilmington, N.C.). Macro-sized particles were separated using a size 50 and 400 mesh sieve from Fisher Scientific (Pittsburgh, Pa.), with resulting particles ranging from 38 μm to 300 μm. Micro-sized particles were separated using a size 400 mesh, isolating particles 38 μm and smaller. Nano-sized vegetable wastes were made by dispersing the micro-sized particles in distilled water, then milling the dispersion to submicron size using a Planetary Ball Mill 100 manufactured by Glen Mills (Clifton, N.J.). Size ranges were confirmed using scanning and transmission microscopy at the Molecular and Cellular Imaging Center, at The Ohio State University, OARDC. However, the tomato paste waste was modified from a micro platy geometry to a more fibrous nano-sized material, whereas the tomato peel waste maintained a plate-like geometry in all sizes.

Mineral Wastes

Carbon fly ash (CFA) was supplied by Cargill Salt of Cargill, Inc. (Akron, Ohio). The CFA was processed in the same manner as the dried tomato wastes. The macro- and micro-CFA fillers possessed plate-like geometry whereas the nano-filler was more spherical in shape.

Calcium carbonate (CaCO₃) was derived from eggshells from store-bought white eggs, and white eggshells donated by Troyer's Home Pantry (Apple Creek, Ohio). The eggshells were soaked in hot water for 10 minutes, and the membranes were peeled from the shells. The resulting CaCO₃ was processed in the same manner as the dried tomato wastes. All sizes maintained a plate-like geometry.

Lignocellulosic Wastes

Guayule plants were donated by Panaridus, LLC (Casa Grande, Ariz.). Bark from the guayule was removed from the branches, placed in ice water, sieved, and then blended in aqueous NH₄OH at pH 10, using a Waring blender. The resulting homogenate was pressed through eight layers of cheesecloth, and the remaining solids were dried at 50° C. for 24 h in a convection oven. The guayule bark bagasse (GB) was processed identically to the dried tomato wastes. The submicron geometry was a combination of fibrous and spherical particles.

Taraxacum kok-saghyz dandelion floss (DF) was harvested from field and high tunnel-grown plants. The DF was processed identically to the dried vegetable wastes. The DF fillers had special geometry.

Imaging

The filler materials and manufactured films were imaged at the Molecular and Cellular Imaging Center (MCIC) at the Ohio Agricultural Research and Development Center (OARDC) in Wooster, Ohio. Fillers were adhered to aluminum stubs, and coated with platinum. A Hitachi S-3500N scanning electron microscope (Tokyo, Japan) was operated in a high vacuum to image the fillers. Filler samples for transmission electron microscopy (TEM) were prepared by diluting submicron fillers in distilled water, placing the suspension onto formovar carbon-coated grids, followed negative staining with 2% uranyl acetate. Fillers were imaged using a Hitachi H-7500 (Tokyo, Japan).

Latex Films—Emulsion Chemistry/Compounding

Guayule latex, Vytex®, and Centex latices were compounded with varying amounts and sizes of tomato paste, tomato peel, carbon fly ash, eggshells (calcium carbonate), and guayule bagasse fillers, with the compound formulations as specified in Table 4, below. The maximum filler loadings were determined by obtaining unstable emulsions. Solid fillers were suspended in distilled water and stirred for 15 minutes using a 30 rpm hand mixer prior to addition to the latex mixture. The sulfur emulsion, antioxidant dispersion, chemical accelerators, and zinc oxide dispersion were all supplied by Akron Dispersions of Akron, Ohio. The ammonium hydroxide was supplied by W.W. Grainger, Inc. (Salt Lake City, Utah).

TABLE 4
Latex Emulsion Compounding Recipe

| | Dry Weight |
|---|---|
| | (PHR) |
| Rubber | 100 |
| ZDEC Accelerator | 0.5 |
| DPG Accelerator | 0.4 |
| Sulfads ® Accelerator | 0.6 |
| Sulfur | 2 |
| Ammonium Hydroxide | 1 |
| ZnO | 0.3 |
| Antioxidant | 2 |
| Waste Filler | 1, 2, 5, 10 |

The final latex emulsion was 48% solids by volume. The emulsion was prevulcanized for 2.5 hours using a 30 rpm hand mixer, and stirred prior to dipping.

Dipping and Curing

The polymers in this example were made using the following protocol: a heated stainless steel plate former was dipped for a 10 second dwell time into a coagulant solution of 25% aqueous calcium nitrate in 70% isopropyl alcohol. After the solvent evaporated, the coagulant-coated former was dipped into a latex emulsion and a thin film of coagulated latex was deposited for 45 seconds. This dwell time created a uniform thickness of 0.23 mm for all samples. Once the latex gelled via heating for 15 minutes at 100° C., it was leached in water for 15 minutes at 55° C., followed by stripping of the former and subsequent vulcanization of the rubber article for 20 minutes at 105° C. The rubber film was then placed in a dryer post-vulcanization for 60 minutes at 60° C. All thin films in this example were made using a Diplomat automated dipper (DipTech Systems Inc., Kent, Ohio).

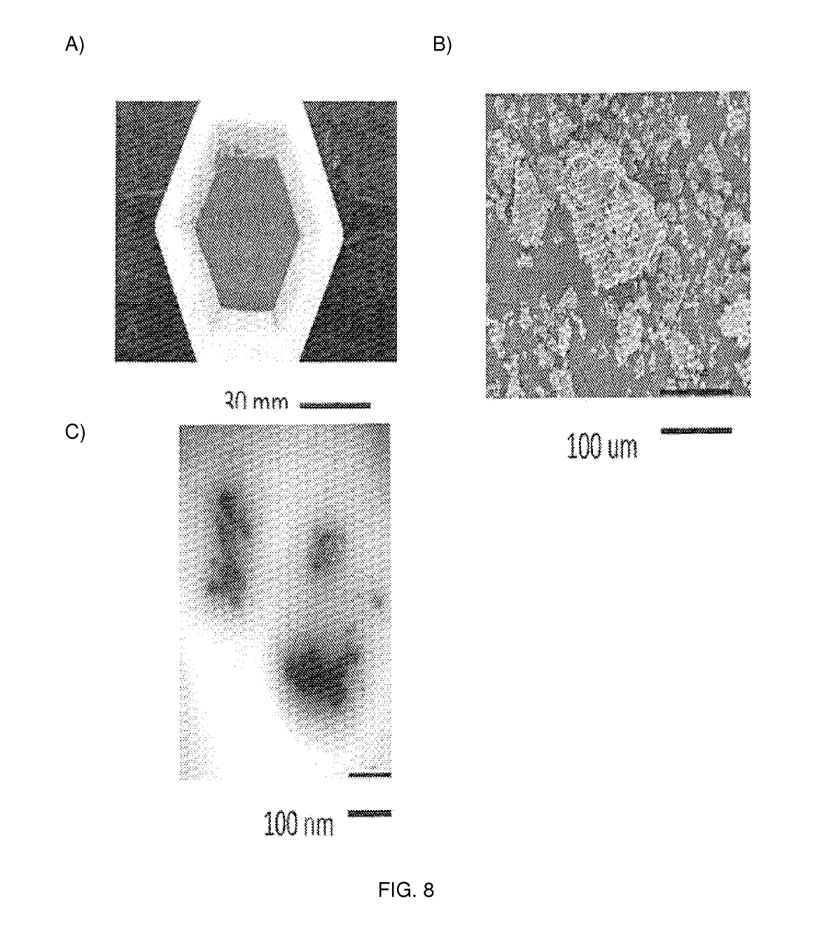

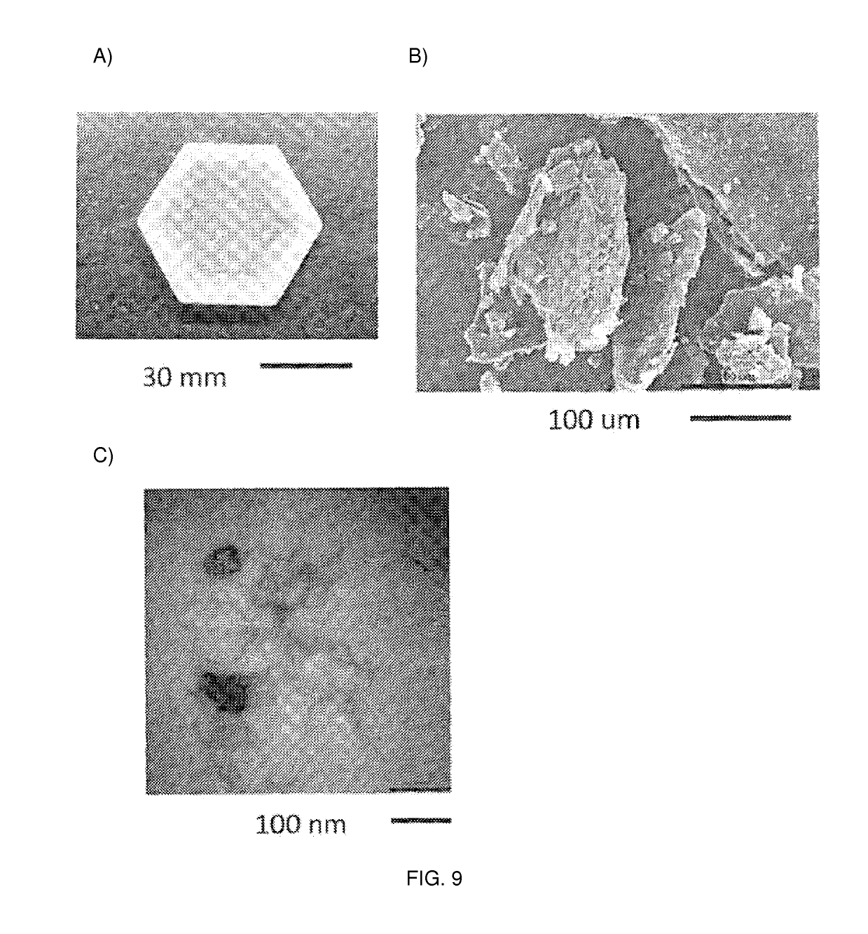

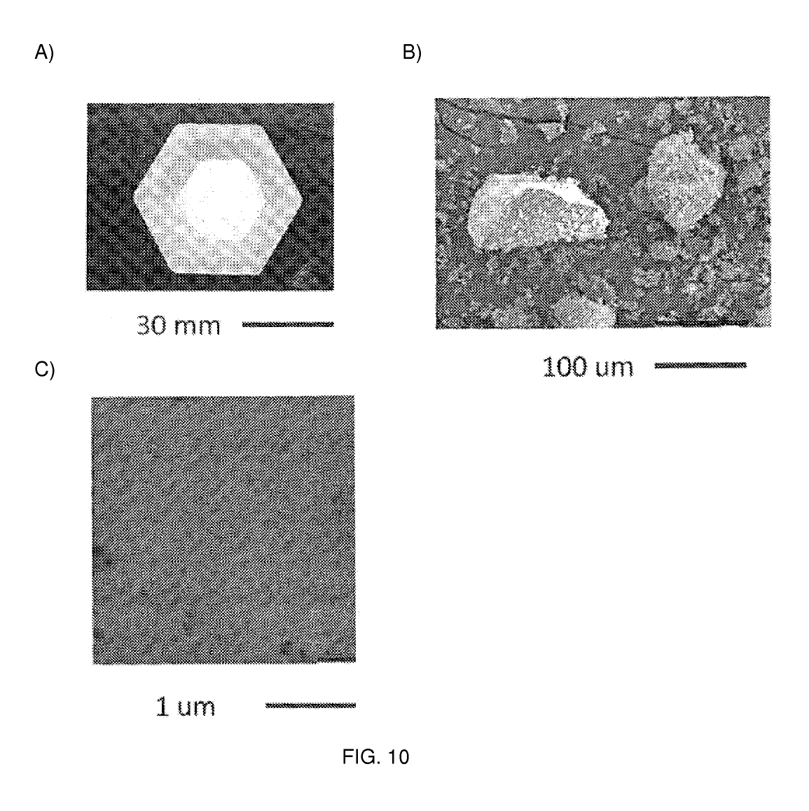

FIGS. 8A-C are SEM and TEM images of the carbon fly ash fillers, showing primarily spherical geometry. FIGS. 9A-C are SEM and TEM images of guayule bark bagasse fillers, showing the geometry change from platy/spherical for micro-sized bagasse filler to more fiber-like for nano-sized bagasse filler. FIGS. 10A-C are SEM and TEM images of calcium carbonate fillers from eggshells, showing spherical geometry in both micro- and nano-sized calcium carbonate fillers.

Mechanical Properties

Four dumbbell samples of each film at each dwell time were made, cut using Die C according to ASTM D 412. Evaluation of the tensile mechanical properties followed ASTM D 412 protocols and were measured using a tensiometer (Model 3366, Instron, Norwood, Mass.). The samples of each film were compared to control samples of unfilled films compounded with the same formulation.

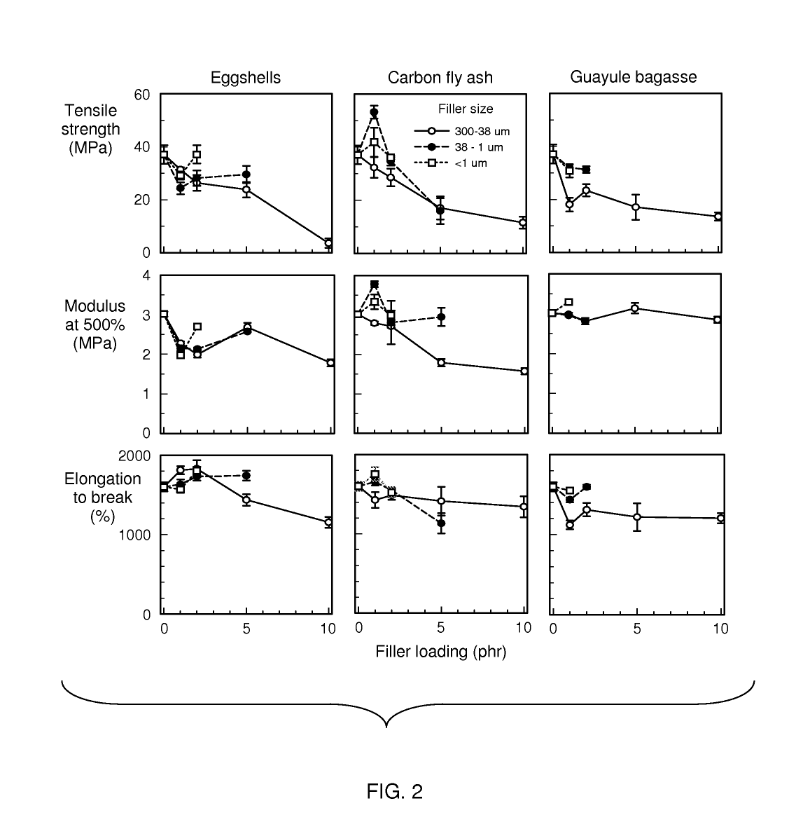

The different fillers and sizes were found to have unexpected effects in the Centex NRL, as seen from the graphs in FIG. 2, which display the physical properties of the waste-filled Centex NRL dipped films. Also, instead of increased loading increasing the modulus, as would be expected for mineral filler, the fillers made from eggshells consistently reduced the modulus compared to unfilled films made with the same formulation (FIG. 2, center left). The carbon fly ash filler, however, significantly increased tensile strength at a 1 PHR loading, and increased modulus at 1 PHR loading of the two smallest fillers (FIG. 2, center). The guayule bagasse had little effect on the modulus at the loadings and sizes tested (FIG. 2, center right). It is apparent from this data that making a filler smaller does not necessarily lead to a reinforcing effect or a stiffer film. In general, in the Centex NRL, the micro-fillers performed as well or better than the nano-fillers, although both fillers led to films with better physical properties than the macro-fillers (FIG. 2).

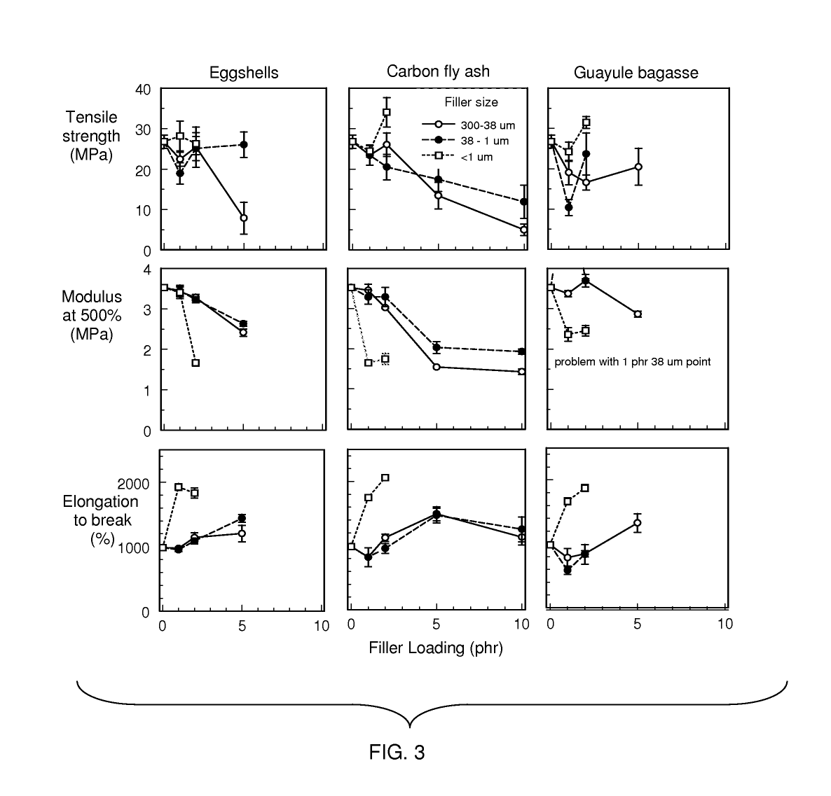

The unfilled Vytex® latex films had a lower tensile strength than the Centex films, a slightly higher modulus, and a much lower elongation to break (cf. FIG. 3 and FIG. 2). All Vytex® films showed an increase in elongation to break when low loading of fillers of the three sizes were tested (FIG. 3, center row), but elongation then decreased as the CFA filler loading increased from 5 PHR to 10 PHR (FIG. 3, bottom center). All nano-fillers approximately doubled the elongation to break of the films at 1 PHR and 2 PHR (FIG. 3, bottom row). When the same fillers were used to make films from low protein Vytex®, different effects on the physical properties were observed compared to Centex NRL. Increased loadings of all three nano-fillers made the Vytex® films stronger but also markedly softer (lower modulus) and stretchier (higher elongation to break) compared to larger-sized fillers. As for the Centex films, the CFA filler created the strongest films at low loadings. FIG. 3 displays graphs illustrating the physical properties of the waste-filled Vytex® films.

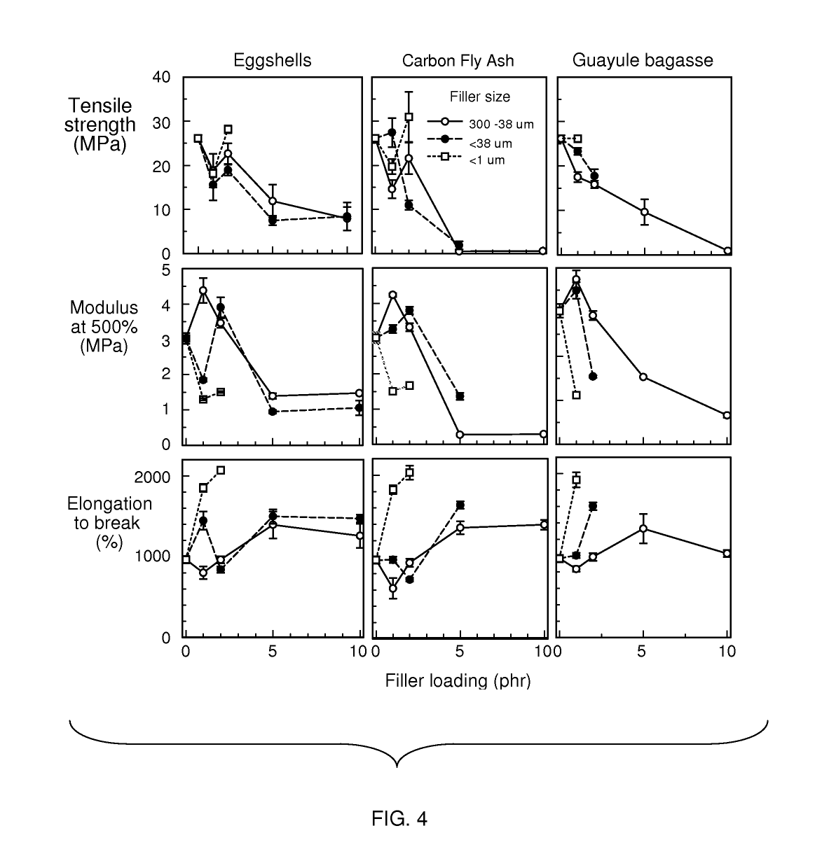

The unfilled guayule latex films (FIG. 4), in the standardized formulation used (Table 1), had a tensile strength and elongation to break very similar to the Vytex® films (FIG. 3), but a lower modulus than Vytex®. As was the case with the Vytex® films, the nano-fillers approximately doubled the elongation to break of the guayule films at 1 PHR and 2 PHR.

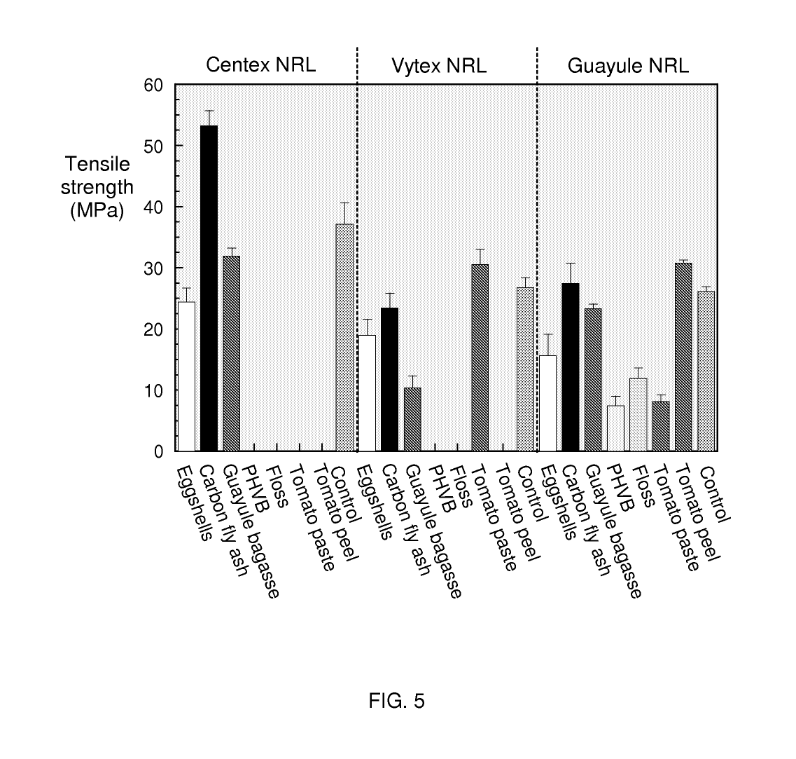

FIG. 5 shows the effect of the micro-fillers on tensile strength in each of the three latices. As seen from this chart, CFA in Centex NRL produced the film with the greatest tensile strength, which was greater than the control Centex film. In the Vytex® latice, tomato paste produced a film with a tensile strength greater than the control Vytex®, and in the guayule latice, tomato peel produced a film with a tensile strength greater than the control guayule film.

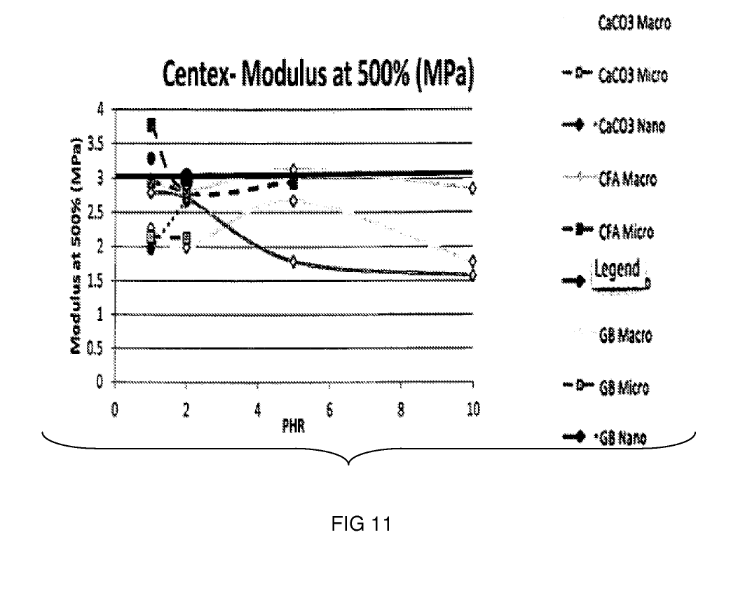

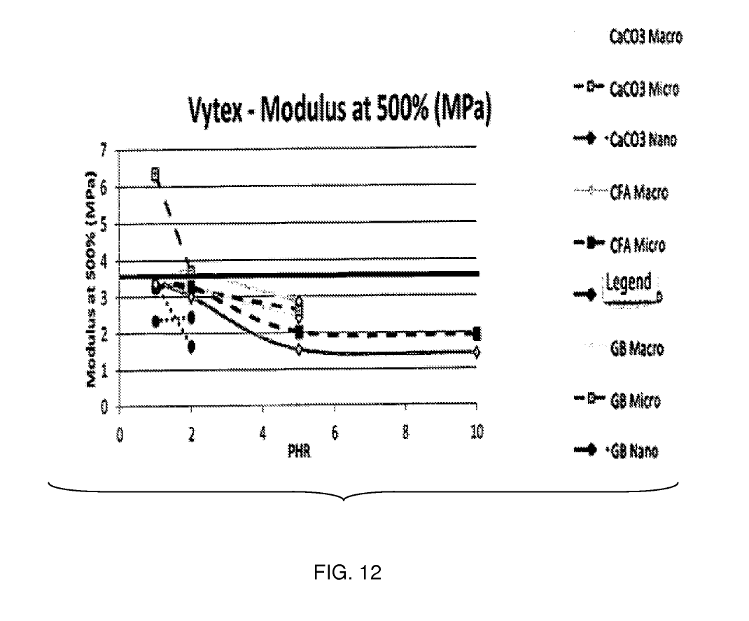

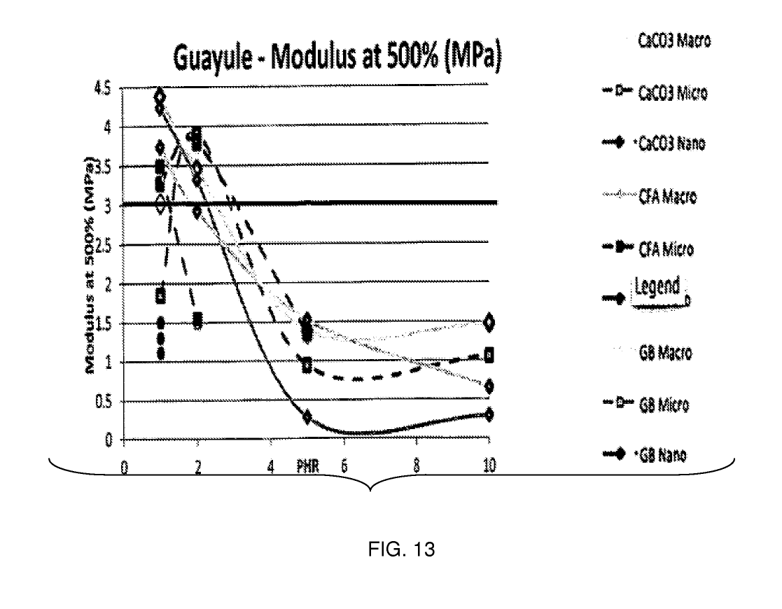

FIGS. 11-13 show graphs of the effect on modulus at 500% of various loadings of waste fillers in each of the three latices. As seen from these figures, the majority of Centex and Vytex® films produced were softer than the controls. The guayule films tested had increased stiffness for micro- and macro-fillers with low loadings, and softened with nano-sized fillers.

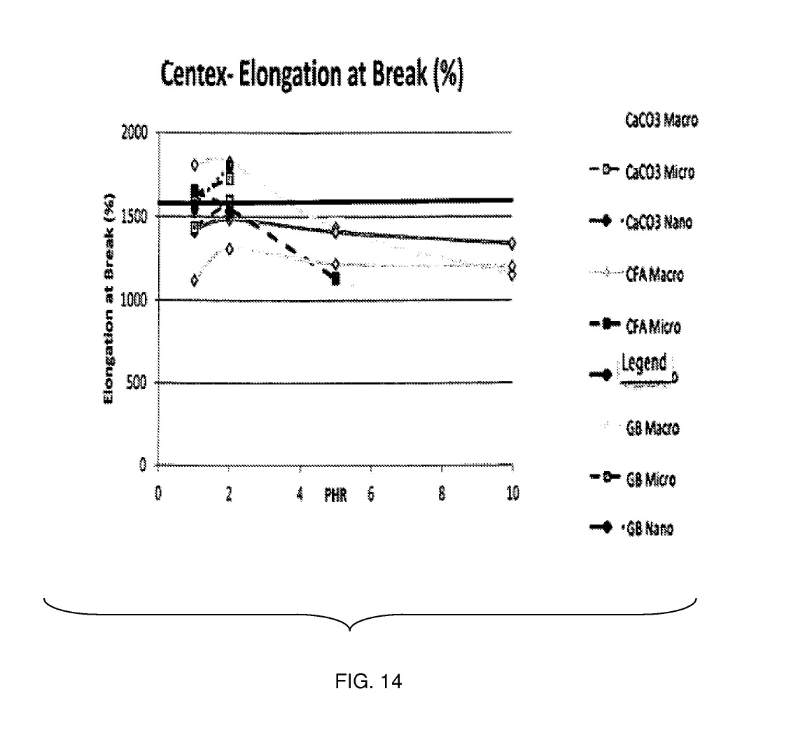

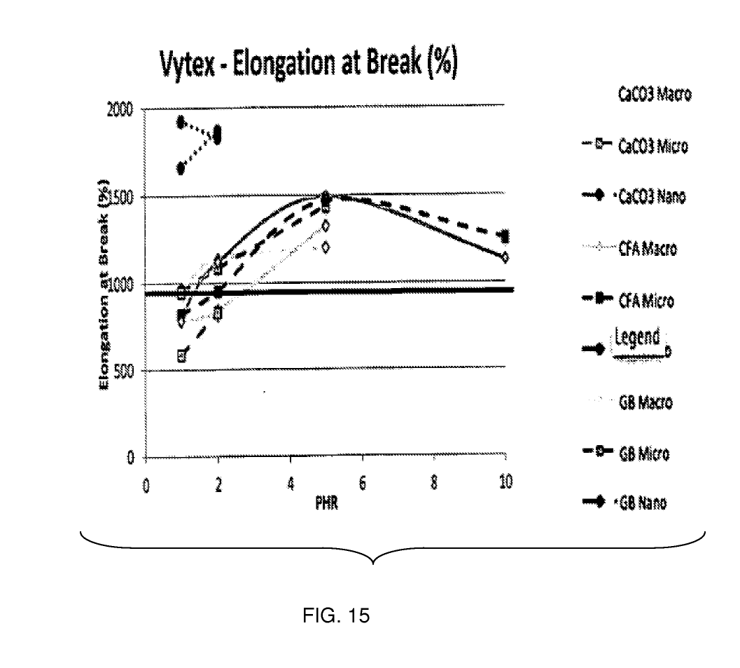

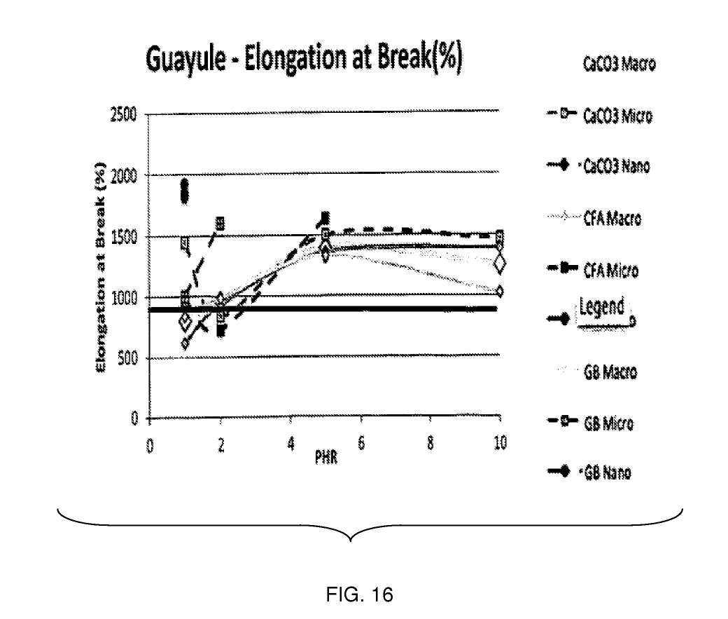

FIGS. 14-16 show graphs of the effect on elongation at break of various loadings of waste fillers in each of the three latices. As seen from these figures, nano-fillers in all latices increased elongation at break. The Vytex® and guayule films had increased elongation at higher filler loadings. The Centex films had decreased elongation with higher filler loadings.

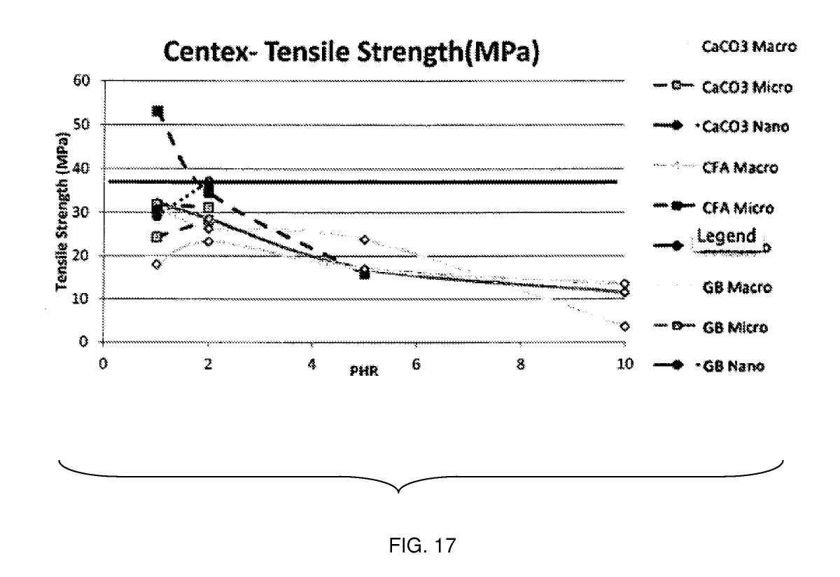

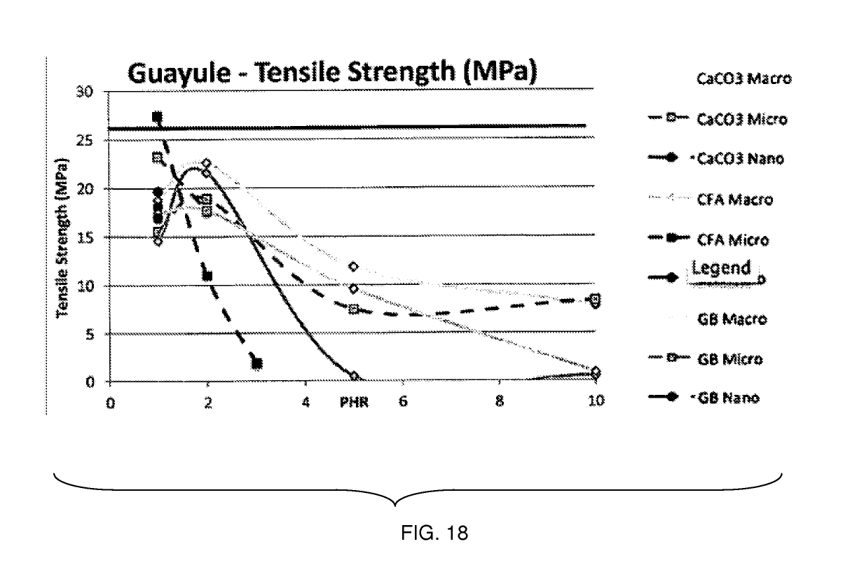

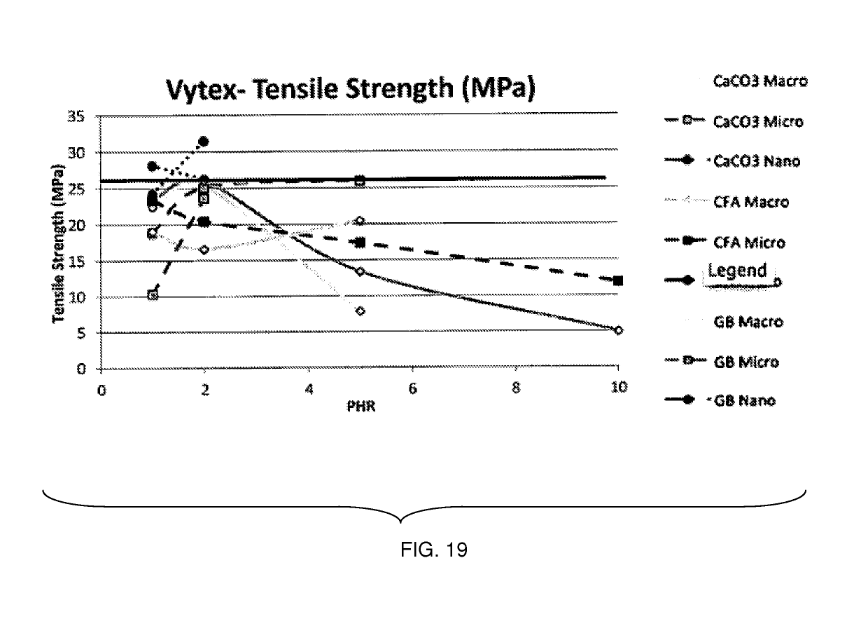

FIGS. 17-19 show graphs of the effect on tensile strength of various loadings of waste fillers in each of the three latices. As seen from these figures, all three latices generally had decreased tensile strength as a result of higher filler loadings. However, various dipped films in each latice had tensile strength above 24 MPa, making them viable for use in surgical gloves.

Unusual Bio-Based Filler Materials

Additional bio-based filler materials were evaluated in dipped films. All tests in this example were performed at 1 PHR filler loading, and used fillers milled to the 1-38 μm (micro-) particle size, but otherwise used the same protocols as described above.

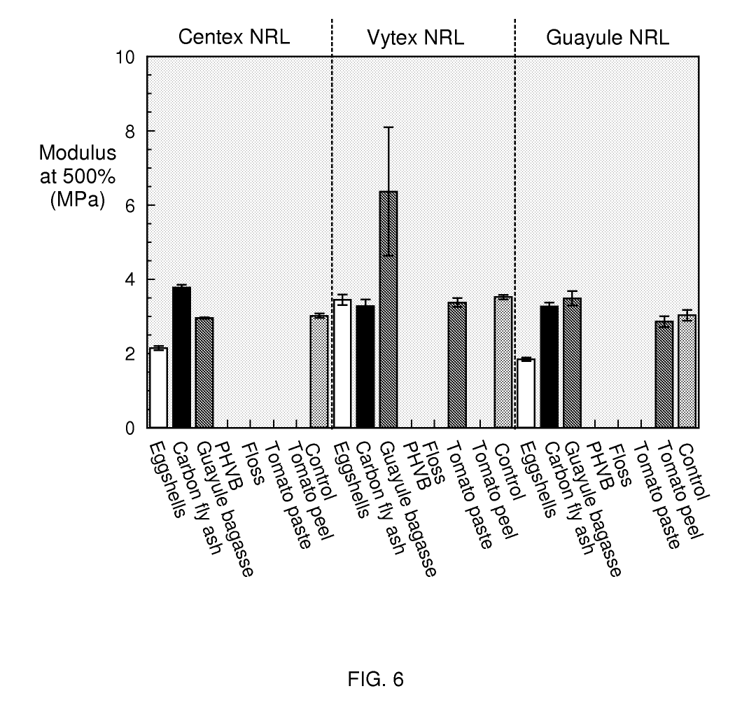

Processed tomato peels, PHBV (a bioplastic), and floss were tested as the fillers and compared against control films. The effect of these fillers on modulus is shown in FIG. 6. As seen in this figure, the tomato paste greatly reduced the strength of GNRL films but strengthened the Vytex® films. This contrasting result was unexpected because these two latices respond quite similarly to the eggshell, carbon fly ash, and guayule bagasse fillers. This differing response also illustrates the need to test any possible filler in a specific latex before discounting it as unsuitable for that latex.

When the moduli at 500% elongation of each film were compared (FIG. 6), the guayule bagasse stiffened the Vytex® film but had little effect on the other two latices. In contrast, the eggshells only affected the Centex NRL and GNRL moduli and, in both cases, made the films softer. The tomato peels, which strengthened the Vytex® and GNRL films, had little effect on the modulus of the GNRL film. The Vytex® and GNRL films also responded very differently to the tomato paste-based filler, with the GNRL breaking at very low elongation, whereas the Vytex® film elongation was slightly increased. Thus, the properties of films made from the different latexes appear to change independently of each other with the different fillers. Again, the performance in one latex film was not predictive of performance in a film made from a different latex.

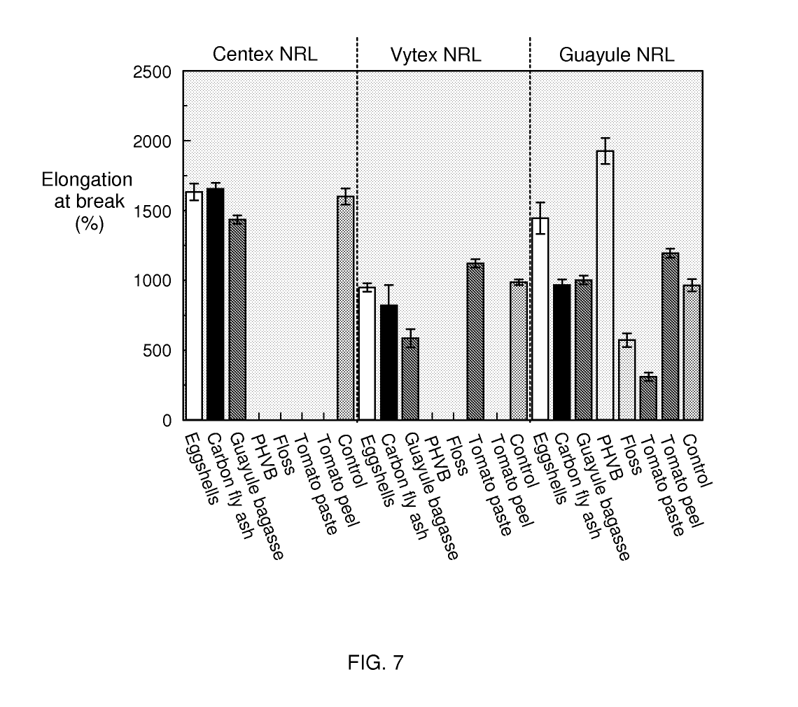

As seen in FIG. 7, micro-fillers generally produced dipped films having elongation at break values comparable to those of the control films. The PHVB filler produced a greater elongation at break than the control in the guayule films but not in the Vytex® or Centex films. The eggshell fillers produced a greater elongation at break than the control in the Centex and guayule films, but not in the Vytex® films. The carbon fly ash filler produced greater elongation at break than the control in Centex films but not in the Vytex® or guayule films.

The compositional differences between the latices cause the different behaviors with the different fillers. The Centex NRL and Vytex® contain the same rubber polymer, so it is the difference in soluble protein content that is the primary variable between these two materials. Soluble protein content is positively correlated with the amount of sulfur in the latex, and impacts the crosslinking density. This difference can be compensated for by the addition of sulfur to low soluble protein compounds. In contrast, both the guayule and Vytex® have very little soluble protein, so the difference in their filler interaction is primarily due to their different rubber particle membrane components, such as proteins and fatty acids, and the difference in their rubber macromolecular structure. The skilled person will thus understand that producing latex films having waste fillers and varying the amount of fatty acids in the latex would be a routine investigation having the benefit of the present disclosure. Similarly, it would be entirely routine and expected to optimize the formulations described herein around the initial standard compound results, or to add more sulfur to the low protein films and/or more fatty acid to the NRL films in combination with fillers.

The waste fillers used in this example favorably altered the physical properties of latex films, and will reduce the cost of producing latex products such as gloves. The data obtained shows the softness and elongation to break of Centex films can be improved by the addition of 1 PHR or 2 PHR macro-, micro-, and/or nano-eggshell fillers, while still exceeding the ASTM 3577 surgical glove tensile requirements (Table 1, above). 5 PHR loadings still easily meet the performance specifications. The carbon fly ash fillers also give excellent results at 1 PHR and 2 PHR at all filler sizes, as seen from Table 2 above. However, the guayule bagasse fillers require the smaller micro- or nano-sized fillers to consistently yield surgical glove performance of the Centex NRL films. Table 4, below, displays the physical properties of films made from Centex natural rubber latex with different loadings of fillers. In Table 5, “n/a” indicates that a uniform dispersion of filler was not obtained, and shaded cells indicate films that exceed the ASTM D 3577 standard

TABLE 5
Physical Properties of Waste-Filled Centex Films (values are the mean of
6 ± s.e., and shaded cells indicate films that exceed the ASTM D 3577
standard for rubber surgical gloves)

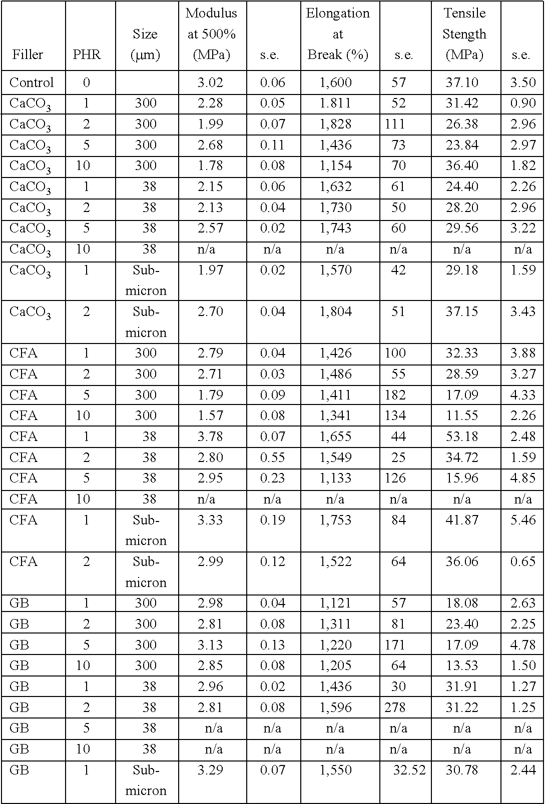

The unfilled low protein Vytex® films had excellent physical characteristics in the standard compound used in the examples above. However, they were significantly strengthened by the fillers using smaller (micro- and nano-) filler sizes. (Table 6.) Guayule bagasse loading added a large effect; 2 PHR of the 38 μm bagasse filler more than doubled the strength of the 1 PHR film and almost meet the surgical specification. Also, the macro-eggshell and carbon fly ash fillers at 2 PHR exceeded the surgical glove specification. Table 5, below, displays the physical properties of films made from Vytex®, a low protein natural rubber latex, with different loadings of waste fillers. In Table 6, “n/a” indicates that a uniform dispersion of filler was not obtained, and shaded cells indicate films that exceed the ASTM D 3577 standard specification for rubber surgical gloves.

TABLE 6
Physical Properties of Waste-Filled Vytex ® Films (values are the
mean of 6 ± s.e., and shaded cells indicate films that exceed the ASTM D 3577
standard for rubber surgical gloves)

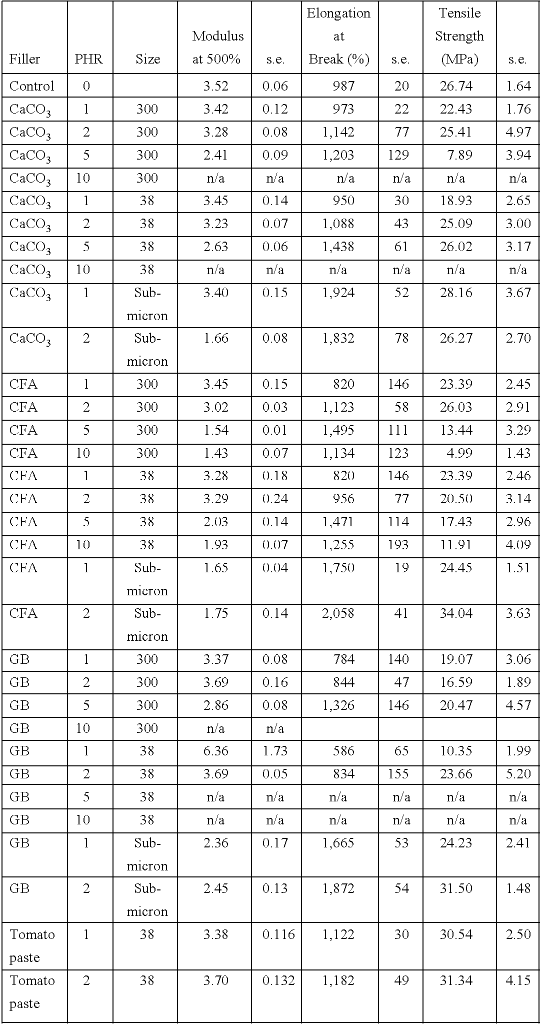

Table 7, below, displays the physical properties of films made from guayule latex with different loadings of fillers. In Table 6, “n/a” indicates that a uniform dispersion of filler was not obtained, and shaded cells indicate films that exceed the ASTM 3577 standard specification for rubber surgical gloves.

TABLE 7
Physical Properties of Waste-Filled Guayule Films (values are the mean
of 6 ± s.e., and shaded cells indicate films that exceed the ASTM D 3577
standard for rubber surgical gloves)

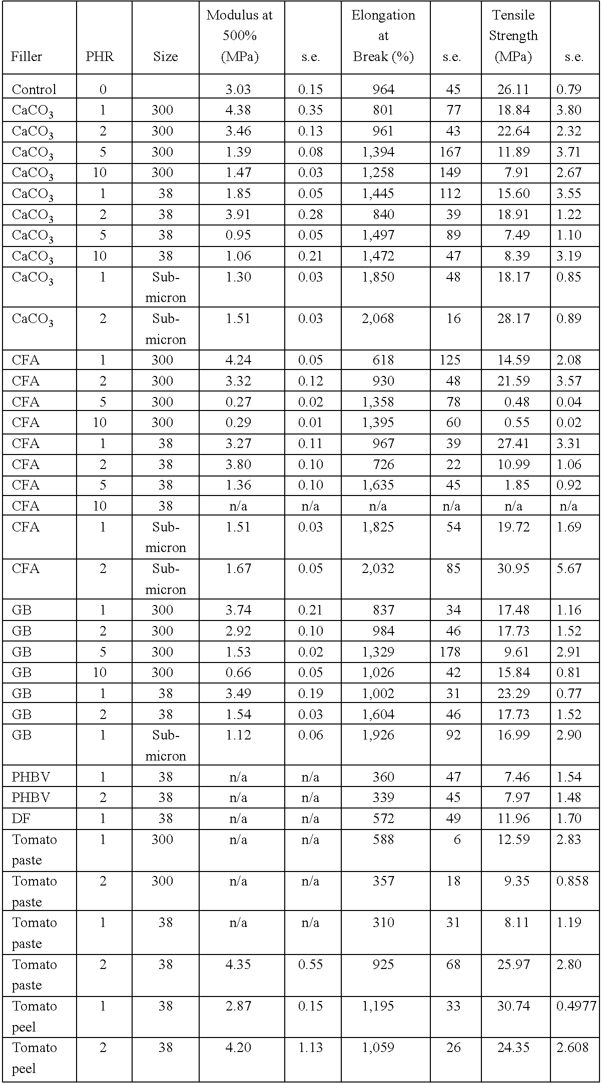

In general, the rubber compounds tested had stronger tensile properties with smaller particle sizes at lower loadings. Reduction of particle size increased ultimate elongation as well as stress at 500% elongation and tensile strength, while the increase of the filler load in the compound increased ultimate elongation but decreased stress at 500% elongation and tensile strength. These results show existing fillers can be replaced with sustainable waste-based fillers that are capable of reproducing desirable properties and meeting product standards.

Certain embodiments of the latex compounds, latex films, and methods disclosed herein are defined in the above examples. It should be understood that these examples, while indicating particular embodiments of the invention, are given by way of illustration only. From the above discussion and these examples, one skilled in the art can ascertain the essential characteristics of this disclosure, and without departing from the spirit and scope thereof, can make various changes and modifications to adapt the compositions and methods described herein to various usages and conditions. Various changes may be made and equivalents may be substituted for elements thereof without departing from the essential scope of the disclosure. In addition, many modifications may be made to adapt a particular situation or material to the teachings of the disclosure without departing from the essential scope thereof.

What is claimed is:

1. A latex compound comprising:
a rubber latex component;
a crosslinking agent;
one or more accelerators; and
a filler comprising vegetable wastes, mineral wastes, or lignocellulosic wastes.

2. The latex compound of claim 1, wherein the cross linking agent comprises a source of sulfur.

3. The latex compound of claim 1, wherein the rubber latex component is selected from the group consisting of: Hevea brasiliensis; guayule (Parthenium argentatum); gopher plant (Euphorbia lathyris); mariola (Parthenium incanum); rabbitbrush (Chrysothanmus nauseosus); candelilla (Pedilanthus macrocarpus); Madagascar rubbervine (Cryptostegia grandiflora); milkweeds (Asclepias syriaca, speciosa, subulata, et al.); goldenrods (Solidago altissima, graminifolia, rigida, et al.); Russian dandelion (Taraxacum kok-saghyz); mountain mint (Pycnanthemum incanum): American germander (Teucreum canadense); tall bellflower (Campanula americana); plants from the Asteraceae (Compositae), Euphorbiaceae, Campanulaceae, Labiatae, and Moraceae families; and a combination thereof.

4. The latex compound of claim 1, wherein the rubber latex component is selected from the group consisting of guayule natural rubber latex, Vytex® latex, and Centex latex.

5. The latex compound of claim 1, wherein the filler comprises macro-sized particles having an average particle size of from about 38 μm to about 300 μm.

6. The latex compound of claim 1, wherein the filler comprises micro-sized particles having an average particle size of from about 1 μm to about 38 μm.

7. The latex compound of claim 1, wherein the filler comprises nano-sized particles having an average particle size of less than about 1 μm.

8. The latex compound of claim 1, wherein the one or more accelerators comprises ZDEC, DPG, Sulfads®, or a combination thereof.

9. The latex compound of claim 1, wherein the filler comprises carbon fly ash.

10. The latex compound of claim 1, wherein the filler comprises eggshells.

11. The latex compound of claim 1, wherein the filler comprises guayule bark bagasse.

12. The latex compound of claim 1, wherein the filler comprises tomato peel.

13. The latex compound of claim 1, wherein the filler comprises tomato paste.

14. The latex compound of claim 1, wherein the filler comprises PHBV.

15. The latex compound of claim 1, wherein the filler comprises floss.

16. The latex compound of claim 1, further comprising one or more of: ammonium hydroxide, antioxidants, or ZnO.

17. The latex compound of claim 1, wherein the rubber component is Centex latex, and the filler comprises eggshells at a concentration of from about 1 PHR to about 5 PHR.

18. The latex compound of claim 1, wherein the rubber component is Centex latex, and the filler comprises carbon fly ash at a concentration of from about 1 PHR to about 5 PHR.

19. The latex compound of claim 1, wherein the rubber component is Centex latex, and the filler comprises micro-sized or nano-sized guayule bark bagasse.

20. The latex compound of claim 1, wherein the rubber component is Vytex® latex, and the filler comprises micro-sized or nano-sized guayule bark bagasse.

21. The latex compound of claim 1, wherein the rubber component is Vytex® latex, and the filler comprises macro-sized eggshells.

22. The latex compound of claim 1, wherein the rubber component is Vytex® latex, and the filler comprises macro-sized carbon fly ash.

23. The latex compound of claim 1, wherein the filler is present at about 2 PHR.

24. The latex compound of claim 1, wherein the rubber component is guayule NRL, and the filler comprises nano-sized eggshells.

25. The latex compound of claim 1, wherein the rubber component is guayule NRL, and the filler comprises micro-sized or nano-sized carbon fly ash.

26. The latex compound of claim 1, wherein the rubber component is guayule NRL, and the filler comprises micro-sized tomato peel.

27. The latex compound of claim 1, wherein the rubber component is guayule NRL, and the filler comprises micro-sized tomato paste.

28. A latex film comprising the latex compound of claim 1.

29. The latex film of claim 28, wherein the film has a thickness ranging from about 0.03 mm to about 0.26 mm.

30. The latex film of claim 28, wherein the film has a tensile strength of greater than 24 MPa.

31. The latex film of claim 28, wherein the film has an elongation to break of greater than 750%.

32. The latex film of claim 28, wherein the film has a modulus at 500% elongation of less than 5.5 MPa.

33. A method of making a waste-filled dipped film comprising:
compounding a latex emulsion comprising at least one waste filler selected from the group consisting of tomato peel, tomato paste, floss, PHVB, guayule bark bagasse, carbon fly ash, and eggshells; and
crosslinking the latex emulsion through a vulcanization process to produce a waste-filled dipped film.

34. The method of claim 33, wherein a former is dipped in the latex emulsion for a dwell time to deposit a film of latex on the former.

35. The method of claim 33, wherein the former is coated with a coagulant prior to dipping in the latex emulsion.

36. The method of claim 33, wherein the dwell time is from about 5 seconds to about 60 seconds.

37. The method of claim 33, wherein the dwell time is about 10 seconds.

38. The method of claim 33, further comprising the step of milling or sieving the waste filler to obtain a desired particle size prior to compounding the latex emulsion.

39. The product of the method of claim 33.

40. A surgical glove comprising a latex film of claim 28.

41. A condom comprising a latex film of claim 28.

42. A kit for producing a waste-filled dipped film comprising:
a first container housing a rubber latex component; and
a second container housing one or more waste fillers.

43. The kit of claim 42, further comprising one or more of: accelerators, ammonium hydroxide, ZnO, a sulfur dispersion, a coagulant solution, or a former.

44. The kit of claim 42, wherein the kit comprises multiple waste fillers in multiple containers.
